(19) United States
(12) Patent Application Publication
(10) Pub. No.: US 2026/0368210 A1
(43) Pub. Date: Nov. 19, 2026

(54) RISK ANALYSIS SYSTEM, RISK ANALYSIS METHOD, AND RISK ANALYSIS PROGRAM

(71) Applicant: Hitachi, Ltd., Tokyo (JP)

(72) Inventors: Kenta SAKON, Tokyo (JP); Masatoshi SEKINE, Tokyo (JP); Tomoyuki MYOJIN, Tokyo (JP); Naoto SATO, Tokyo (JP); Daisuke SHIMBARA, Tokyo (JP)

(21) Appl. No.: 19/153,574

(22) PCT Filed: Jan. 31, 2024
(86) PCT No.: PCT/JP2024/003136

§ 371 Date: Aug. 4, 2025

(30) Foreign Application Priority Data
Feb. 8, 2023 (JP) 2023-017250

(51) Int. Cl. G06F 16/31

(52) U.S. Cl. CPC G06F 16/313

(57) ABSTRACT

A risk analysis support device (1S) reads a keyword-assigned dataset and a keyword-unassigned dataset. The keyword-assigned dataset is a dataset in which each data is assigned a feature of each data and assigned a keyword linked to the feature. The keyword-unassigned dataset is a dataset in which each data is not assigned a feature of each data and not assigned a keyword linked to the feature. The risk analysis support device (1S) generates distribution of each data in the keyword-assigned dataset and the keyword-unassigned dataset in a latent space, and selects, according to a distance between amounts of features of respective pieces of data, first data in the keyword-assigned dataset that is similar to second data in the keyword-unassigned dataset. When there is a feature of the first data that is determined to be common to the second data, the risk analysis support device (1S) assigns the feature and a keyword linked to the feature to the second data.

### CROSS-REFERENCE TO RELATED APPLICATIONS

This application is a U.S. national stage application of International Application No. PCT/JP2024/003136, filed Jan. 31, 2024, which claims benefit of priority from JP 2023-017250, filed Feb. 8, 2023, the contents of both which are incorporated herein by reference.

### TECHNICAL FIELD

The present invention relates to a risk analysis support system, a risk analysis support device, and a risk analysis support program.

### BACKGROUND ART

The quality of a machine learning model depends on training data and test data (hereinafter referred to as the “target dataset”) that are used for learning of the machine learning model. Therefore, for preventing the omission of risk analyses of the machine learning model, it is important to extract all variations in the target dataset that act as risk factors for the machine learning model.

As a technology for preventing the omission of risk analyses, Patent Document 1 discloses a technology for reusing the results of risk analysis of a former system that is similar or identical in control structure to a system to be analyzed.

Further, the HAZOP (Hazard and Operability Studies) method is known as a method for thoroughly identifying potential hazards in new chemical processes, evaluating their impacts, and taking safety measures. Applying the HAZOP method to the evaluation of the machine learning model makes it possible to use keywords for each domain of the target dataset and extract variations in the target dataset that act as the risk factors for the machine learning model.

### PRIOR ART DOCUMENT

### Patent Document

Patent Document 1: JP-2020-017238-A

### SUMMARY OF THE INVENTION

### Problem to be Solved by the Invention

However, the technology disclosed in Patent Document 1 extracts all system control patterns, and is unable to extract all variations in training data that act as the risk factors for the machine learning model.

Moreover, if there is no existing domain identical to the training data or the test data in a case where the HAZOP method is used to evaluate the machine learning model, the keywords cannot be used. This makes it impossible to extract variations in the training data that act as risk factors for the machine learning model.

The present invention has been made in view of the above circumstances. An object of the present invention is to reduce the omission of extraction of variations in the target dataset that act as the risk factors for machine learning models.

### Means for Solving the Problem

In order to solve the above problem, according to an aspect of the present invention, there is provided a risk analysis support system that supports risk analysis of a machine learning model, the risk analysis support system including a memory and a control section, and the control section reads a keyword-assigned dataset and a keyword-unassigned dataset, the keyword-assigned dataset being a dataset in which each data is assigned a feature of each data and assigned a keyword linked to the feature, the keyword-unassigned dataset being a dataset in which each data is not assigned a feature of each data and not assigned a keyword linked to the feature, generates distribution of each data in the keyword-assigned dataset and the keyword-unassigned dataset in a latent space based on an amount of feature of a predetermined dataset, selects, according to a distance between an amount of feature of each data in the keyword-assigned dataset and an amount of feature of each data in the keyword-unassigned dataset, first data in the keyword-assigned dataset that is similar to second data in the keyword-unassigned dataset, and, when there is a feature of the first data that is determined to be common to the second data, assigns the feature and a keyword linked to the feature to the second data.

### Advantages of the Invention

The present invention makes it possible to reduce the omission of extraction of variations in the target dataset that act as the risk factors for machine learning models.

### BRIEF DESCRIPTION OF THE DRAWINGS

FIG. 1 is a diagram illustrating an example of a configuration of a risk analysis support system according to a first embodiment.

FIG. 2A is a diagram illustrating examples of a keyword-assigned dataset according to the first embodiment, a feature of the keyword-assigned dataset, and a keyword assigned to the keyword-assigned dataset.

FIG. 2B is a diagram illustrating an example of a keyword-unassigned dataset according to the first embodiment.

FIG. 3 is a flowchart illustrating an example of a main process that is performed by the risk analysis support system according to the first embodiment.

FIG. 4 is a flowchart illustrating an example of a distribution generation process according to the first embodiment.

FIG. 5 is a flowchart illustrating an example of a keyword-assigned dataset selection process according to the first embodiment.

FIG. 6 is a flowchart illustrating an example of a feature selection process according to the first embodiment.

FIG. 7 is a flowchart illustrating an example of a keyword selection process according to the first embodiment.

FIG. 8 is a diagram illustrating an example of a GUI according to the first embodiment.

FIG. 9 is a flowchart illustrating an example of the keyword-assigned dataset selection process according to a second embodiment.

FIG. 10 is a flowchart illustrating an example of the main process that is performed by the risk analysis support system according to a third embodiment.

FIG. 11 is a flowchart illustrating an example of the distribution generation process according to a fourth embodiment.

FIG. 12 is a diagram illustrating an example of a GUI that displays the distribution of the keyword-assigned dataset according to the fourth embodiment.

FIG. 13 is a diagram illustrating an example of a hardware configuration of a computer.

### MODES FOR CARRYING OUT THE INVENTION

Embodiments according to the disclosure of the present application will now be described with reference to the accompanying drawings. The embodiments, including the drawings, are examples for describing the present application. In the description of the embodiments, omissions and simplifications are appropriately made for clarification. Unless otherwise specified, each of component elements described in conjunction with the embodiments may be singular or plural. Further, an embodiment obtained by combining one embodiment with another embodiment is also included in the embodiment according to the present application.

Identical or similar component elements are designated by the same reference signs, and may be omitted from the description of embodiments following preceding embodiments, or the differences may be mainly described. Further, in some cases where there are a plurality of identical or similar component elements, they may be described with different suffixes added to the same reference signs. Moreover, in some cases where the plurality of component elements need not be distinguished from each other, they may be described without the suffixes.

In the following embodiments, keywords serving as tips for recalling training data previously used to build a machine learning model (hereinafter referred to as the “keyword-assigned dataset”) are assigned to this training data. The keywords depend on a domain (e.g., a field, an area, a category, or the like) to which the training data belongs, and indicate, for example, attributes of a target represented by each data in the training data.

The training data for building a new machine learning model is called a “keyword-unassigned dataset.” A case where a keyword is assigned to the keyword-unassigned dataset will now be considered.

If a keyword-assigned dataset in the same domain as the keyword-unassigned dataset is present, the keyword assigned to the keyword-assigned dataset can be reused as the keyword to be assigned to the keyword-unassigned dataset.

However, if no keyword-assigned dataset in the same domain as the keyword-unassigned dataset is present, the keyword assigned to the keyword-assigned dataset cannot be reused. This may result in the omission of variations in the keyword-unassigned dataset, thereby causing a case in which the potential risks in a new machine learning model that uses a keyword-unassigned dataset may not be able to be grasped in advance.

The present embodiments are configured such that, even in a case where no keyword-assigned dataset in the same domain as the keyword-unassigned dataset is present, it is possible to reuse a keyword that is assigned to the keyword-assigned dataset.

### First Embodiment

### Configuration of Risk Analysis Support System 1S According to First Embodiment

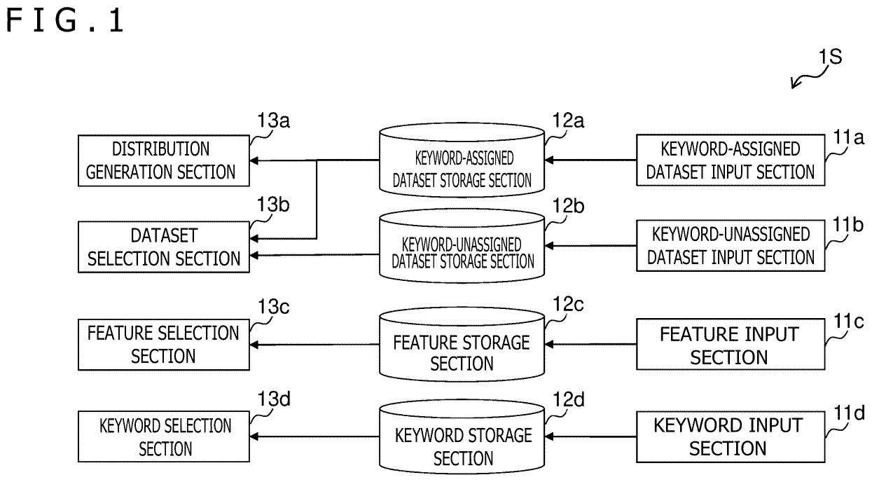

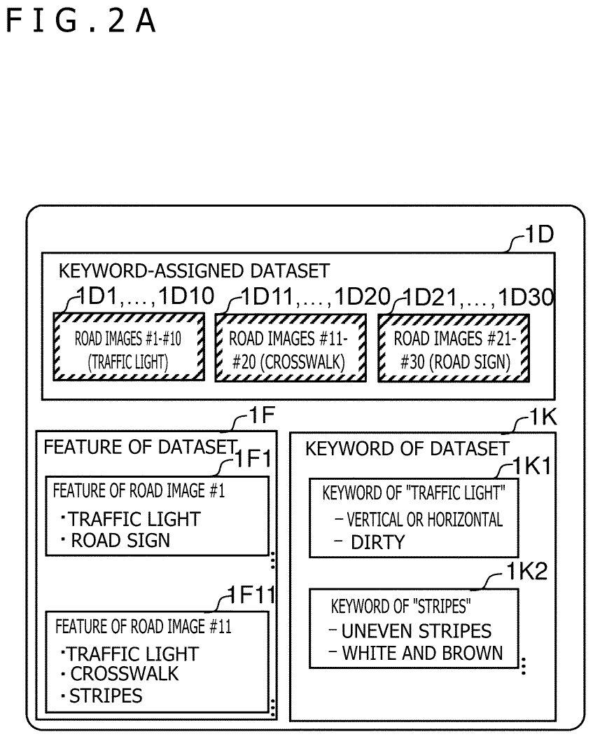

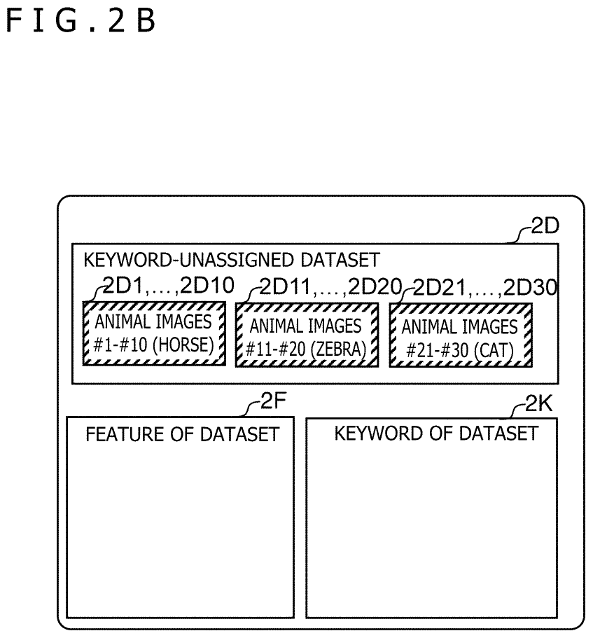

FIG. 1 is a diagram illustrating an example of a configuration of a risk analysis support system 1S according to a first embodiment. FIG. 2A is a diagram illustrating examples of a keyword-assigned dataset 1D according to the first embodiment, a feature 1F of the keyword-assigned dataset 1D, and a keyword 1K assigned to the keyword-assigned dataset 1D. FIG. 2B is a diagram illustrating an example of a keyword-unassigned dataset 2D according to the first embodiment.

The risk analysis support system 1S includes a keyword-assigned dataset input section 11a, a keyword-unassigned dataset input section 11b, a feature input section 11c, and a keyword input section 11d.

Further, the risk analysis support system 1S includes a keyword-assigned dataset storage section 12a, a keyword-unassigned dataset storage section 12b, a feature storage section 12c, and a keyword storage section 12d.

Furthermore, the risk analysis support system 1S includes a distribution generation section 13a, a dataset selection section 13b, a feature selection section 13c, and a keyword selection section 13d. Processing functions of the distribution generation section 13a, the dataset selection section 13b, the feature selection section 13c, and the keyword selection section 13d will be described later.

The keyword-assigned dataset input section 11a receives the keyword-assigned dataset 1D that is input to the risk analysis support system 1S. In the present embodiment, as depicted in FIG. 2A, the keyword-assigned dataset 1D includes traffic light images 1D1, . . . , 1D10, which are road images #1, . . . , #10; crosswalk images 1D11, . . . , 1D20, which are road images #11, . . . , #20; and road sign images 1D21, . . . , 1D30, which are road images #21, . . . , #30.

Moreover, the feature 1F and the keyword 1K linked to the feature 1F are assigned to the keyword-assigned dataset 1D. The feature 1F includes a feature 1Fx of each data 1Dx (x=1 to 30). A keyword 1Kx for recalling each feature 1Fx is linked to each feature 1Fx (x=1 to 30). That is, the feature 1Fx of each data 1Dx and the keyword 1Kx linked to each feature 1Fx are assigned to each data 1Dx (x=1 to 30).

The keyword-assigned dataset 1D input by the keyword-assigned dataset input section 11a is stored in the keyword-assigned dataset storage section 12a.

The keyword-unassigned dataset input section 11b receives the keyword-unassigned dataset 2D that is input to the risk analysis support system 1S. In the present embodiment, as depicted in FIG. 2B, the keyword-unassigned dataset 2D includes horse images 2D1, . . . , 2D10, which are animal images #1, . . . , #10; zebra images 2D11, . . . , 2D20, which are animal images #11, . . . , #20; and cat images 2D21, . . . , 2D30, which are animal images #21, . . . , #30.

The keyword-unassigned dataset 2D input by the keyword-unassigned dataset input section 11b is stored in the keyword-unassigned dataset storage section 12b.

The feature input section 11c receives the feature 1F of the keyword-assigned dataset 1D that is input to the risk analysis support system 1S. The feature 1F of the keyword-assigned dataset 1D, which is input by the feature input section 11c, is stored in the keyword-unassigned dataset storage section 12b.

The keyword input section 11d receives the keyword 1K linked to the feature 1F of the keyword-assigned dataset 1D, which is input to the risk analysis support system 1S. The keyword 1K linked to the feature 1F of the keyword-assigned dataset 1D, which is input by the keyword input section 11d, is stored in the keyword storage section 12d.

### Main Process According to First Embodiment

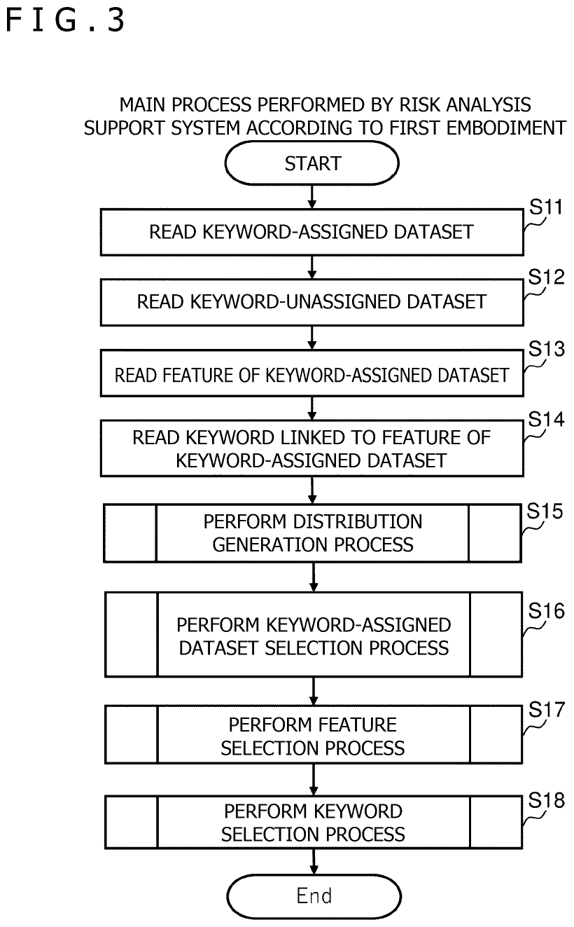

FIG. 3 is a flowchart illustrating an example of a main process that is performed by the risk analysis support system 1S according to the first embodiment.

First, in step S11, the keyword-assigned dataset input section 11a reads the input keyword-assigned dataset 1D, and stores the read keyword-assigned dataset 1D in the keyword-assigned dataset storage section 12a. Next, in step S12, the keyword-unassigned dataset input section 11b reads the input keyword-unassigned dataset 2D, and stores the read keyword-unassigned dataset 2D in the keyword-unassigned dataset storage section 12b.

Subsequently, in step S13, the feature input section 11c reads the feature 1F of the keyword-assigned dataset 1D, and stores the read feature 1F in the feature storage section 12c. Next, in step S14, the keyword input section 11d reads the keyword 1K linked to the feature 1F of the keyword-assigned dataset 1D, and stores the read keyword 1K in the keyword storage section 12d.

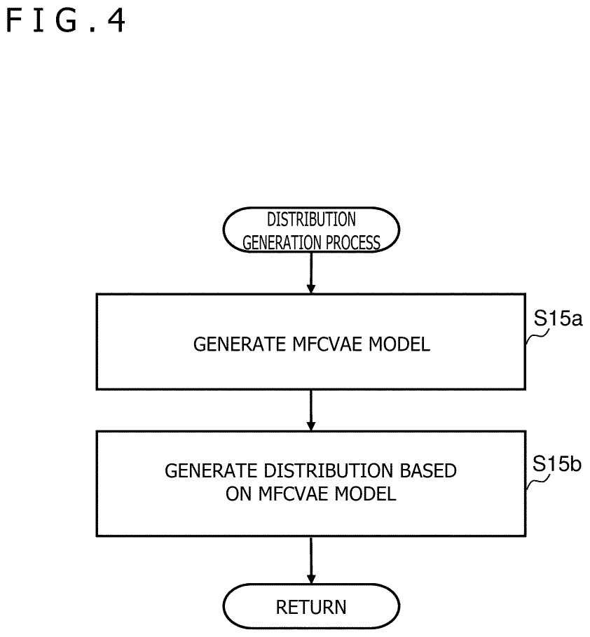

Next, in step S15, the distribution generation section 13a performs a distribution generation process. The distribution generation process will be described in detail later with reference to FIG. 4.

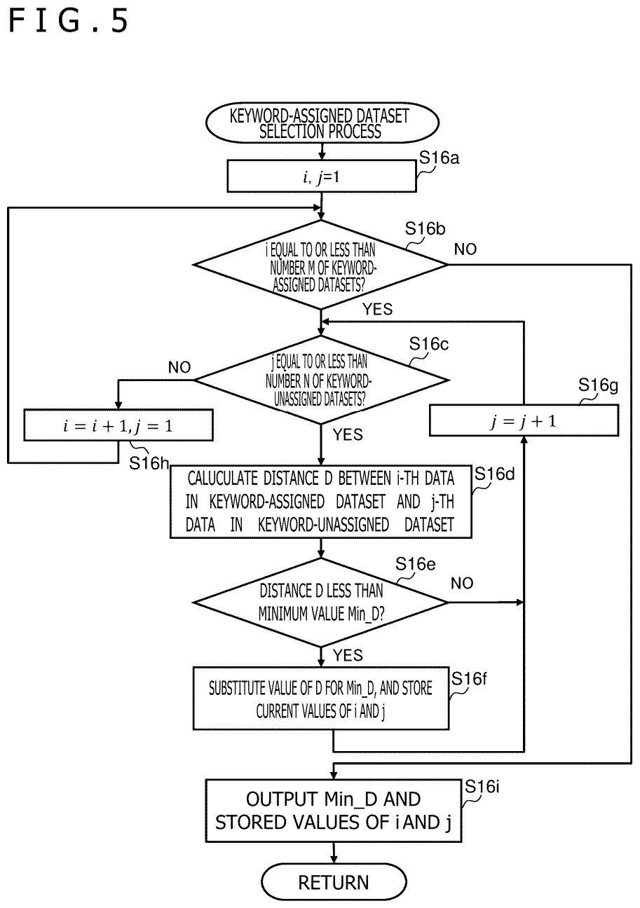

Next, in step S16, the dataset selection section 13b performs a keyword-assigned dataset selection process. The keyword-assigned dataset selection process will be described in detail later with reference to FIG. 5.

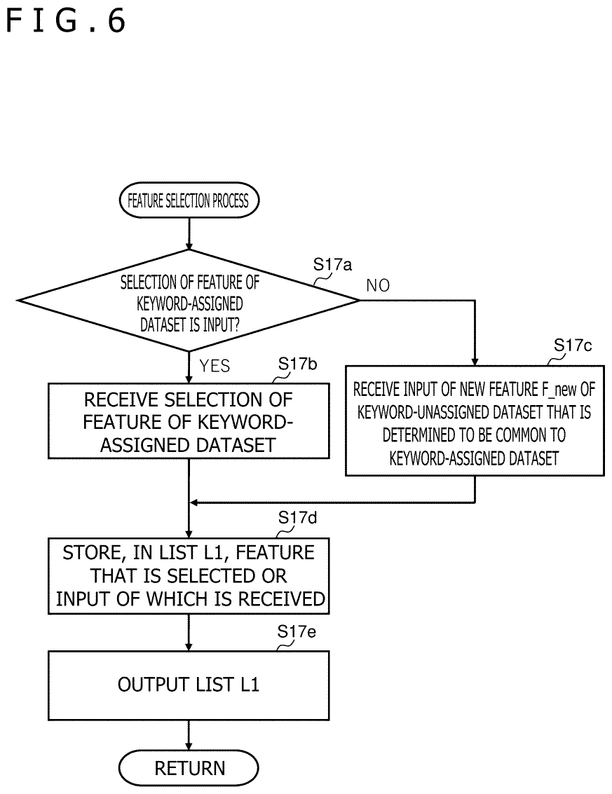

Next, in step S17, the feature selection section 13c performs a feature selection process. The feature selection process will be described in detail later with reference to FIG. 6.

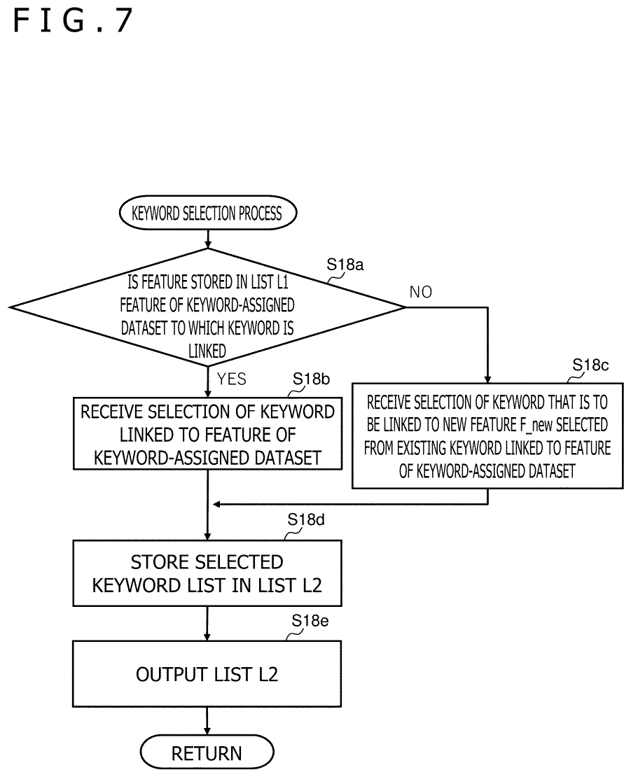

Next, in step S18, the keyword selection section 13d performs a keyword selection process. The keyword feature selection process will be described in detail later with reference to FIG. 7.

### Distribution Generation Process According to First Embodiment

FIG. 4 is a flowchart illustrating an example of the distribution generation process according to the first embodiment.

First, in step S15a, the distribution generation section 13a generates a machine learning model of MFCVAE (Multi-Facet Clustering Variational Autoencoders) (hereinafter referred to as the “MFCVAE model”) by using the keyword-assigned dataset 1D stored in the keyword-assigned dataset storage section 12a.

MFCVAE is an extended variational auto-encoder (VAE) that is able to output latent variables (the amounts of features that are expressed as vectors) from multiple perspectives. The variational auto-encoder is a generative model that uses a neural network and assumes a probability distribution as a space of latent variables. A “perspective” in MFCVAE is the type of a latent variable that is output from MFCVAE, and is the basis for identification by a machine learning model. In the case of character data, the “perspectives” include, for example, “character type” and “character shape (thickness, angle, and the like).” The “feature” is assigned to the dataset by humans in accordance with the result of machine learning model identification.

The variational auto-encoder is disclosed in Document 1: Diederik P Kingma, Max Welling, “Auto-Encoding Variational Bayes,” May 2014., [Retrieved Jan. 27, 2023], Internet <URL: https://arxiv.org/abs/1312.6114>. MFCVAE is disclosed in Document 2: Fabian Falck et al., “Multi-Facet Clustering Variational Autoencoders, Oct. 2021. [Retrieved Jan. 27, 2023], Internet <URL: https://arxiv.org/abs/2106.05241>.

Subsequently, in step S15b, the distribution generation section 13a generates distributions of the keyword-assigned dataset 1D and keyword-unassigned dataset 2D in a latent space based on the MFCVAE model learned in step S15a. The latent space based on the MFCVAE model is a vector space based on multiple latent variables of MFCVAE.

Note that the machine learning model generated in step S15a is not limited to the MFCVAE model based on the keyword-assigned dataset 1D. Further, the latent space in which the distribution is generated in step S15b is not limited to the latent space of MFCVAE. That is, in the distribution generation process, the distributions of the keyword-assigned dataset 1D and keyword-unassigned dataset 2D may be generated in any latent space based on the machine learning model having any encoder (including VAE) learned by use of optional data. Any data may be the keyword-unassigned dataset 2D, or a dataset of the union of the keyword-assigned dataset 1D and keyword-unassigned dataset 2D.

### Keyword-Assigned Dataset Selection Process According to First Embodiment

FIG. 5 is a flowchart illustrating an example of the keyword-assigned dataset selection process according to the first embodiment.

First, in step S16a, the dataset selection section 13b sets indexes i and j to 1.

Next, in step S16b, the dataset selection section 13b determines whether the index i is equal to or less than the number M of keyword-assigned datasets 1D. If i≤M (YES in step S16b), the dataset selection section 13b proceeds to step S16c. Meanwhile, if i>M (NO in step S16b), the dataset selection section 13b proceeds to step S16i.

In step S16c, the dataset selection section 13b determines whether the index j is equal to or less than the number N of keyword-unassigned datasets 2D. If j≤N (YES in step S16c), the dataset selection section 13b proceeds to step S16d. Meanwhile, if j>N (NO in step S16c), the dataset selection section 13b proceeds to step S16h.

In step S16d, the dataset selection section 13b calculates a distance D between the i-th data in the keyword-assigned dataset 1D and the j-th data in the keyword-unassigned dataset 2D. The distance D is assumed to be, for example, the Euclidean distance between the amounts of features of two pieces of data, but is not limited to such a distance.

Next, in step S16e, the dataset selection section 13b determines whether the distance D calculated in step S16d is less than a minimum value Min_D. If D<Min_D (YES in step S16e), the dataset selection section 13b proceeds to step S16f. Meanwhile, if D>Min_D (NO in step S16e), the dataset selection section 13b proceeds to step S16g.

In step S16f, the dataset selection section 13b substitutes the distance D, which is calculated in step S16d, for the minimum value Min_D, and stores the current indexes i and j. Next, in step S16g, the dataset selection section 13b adds 1 to the index j, and returns the process to step S16c.

In step S16h, the dataset selection section 13b adds 1 to the index i, sets j=1, and returns the process to step S16b.

In step S16i, the dataset selection section 13b outputs the minimum value Min_D and the values of the indexes i and j, which are stored in step S16f.

It should be noted that the combination of data in the keyword-assigned dataset 1D and data in the keyword-unassigned dataset 2D, which is output by the keyword-assigned dataset selection process, is not limited to one combination with the smallest distance, but may be a plurality of combinations with distances equal to or less than a predetermined value.

### Feature Selection Process According to First Embodiment

FIG. 6 is a flowchart illustrating an example of the feature selection process according to the first embodiment.

First, in step S17a, the feature selection section 13c determines whether the selection of the feature 1F of the keyword-assigned dataset 1D is input. If the selection of the feature 1F of the keyword-assigned dataset 1D is input (YES step S17a), the feature selection section 13c proceeds to step S17b. Meanwhile, if such a selection is not input (NO in step S17a), the feature selection section 13c proceeds to step S17c.

In step S17b, the feature selection section 13c receives the selection of the feature 1F of the keyword-assigned dataset 1D, which is input through the feature input section 11c by a user of the risk analysis support system 1S. The feature 1F selected in this instance is the feature 1F of the keyword-assigned dataset 1D that is determined by the user to be common to the data in the keyword-assigned dataset 1D and the data in the keyword-unassigned dataset 2D, which are determined to be the closest in distance by the keyword-assigned dataset selection process (FIG. 5).

It should be noted that the feature 1F selected in step S17b is not limited to a feature common to the data in the keyword-assigned dataset 1D and the data in the keyword-unassigned dataset 2D, which are determined to be the closest in distance by the keyword-assigned dataset selection process, but may be a similar feature whose distance, such as the Euclidean distance, is equal to or less than a predetermined value.

Meanwhile, in step S17c, the feature selection section 13c receives, through the feature input section 11c, the input of a new feature F_new of the keyword-unassigned dataset 2D that is determined by the user of the risk analysis support system 1S to be common to the keyword-assigned dataset 1D.

In step S17d, the feature selection section 13c stores, in a list L1, the feature 1F of the keyword-assigned dataset 1D, the selection of which is received in step S17b, or the new feature F_new, the input of which is received in step S17c. The list L1 is to be stored in the feature storage section 12c. Subsequently, in step S17e, the feature selection section 13c outputs the list L1.

### Keyword Selection Process According to First Embodiment

FIG. 7 is a flowchart illustrating an example of the keyword selection process according to the first embodiment.

First, in step S18a, the keyword selection section 13d determines whether the feature read from the list L1 is the feature 1F of the keyword-assigned dataset 1D that is linked to the keyword. If the feature read from the list L1 is the feature 1F of the keyword-assigned dataset 1D (YES in step S18a), the keyword selection section 13d proceeds to step S18b. Meanwhile, if the feature read from the list L1 is the new feature F_new (NO in step S18a), the keyword selection section 13d proceeds to step S18c.

In step S18b, the keyword selection section 13d receives, through the keyword input section 11d, the keyword 1K that is linked to the feature 1F of the keyword-assigned dataset 1D and selected by the user of the risk analysis support system 1S.

Meanwhile, in step S18c, the keyword selection section 13d receives, through the keyword input section 11d, the input of a keyword that is to be linked to the new feature F_new selected from the existing keyword 1K, which is linked to the feature 1F of the keyword-assigned dataset 1D by the user of the risk analysis support system 1S. In step 18c, if the feature 1F common to the data in the keyword-unassigned dataset 2D is not in the keyword-assigned dataset 1D, the new feature F_new is added to a feature 2F of the keyword-unassigned dataset 2D.

In step S18d, the keyword 1K selected in step S18b or S18c is stored in a list L2, which is to be stored in the keyword storage section 12d. Subsequently, in step S18e, the keyword selection section 13d outputs the list L2.

### GUI 50 for Keyword Selection According to First Embodiment

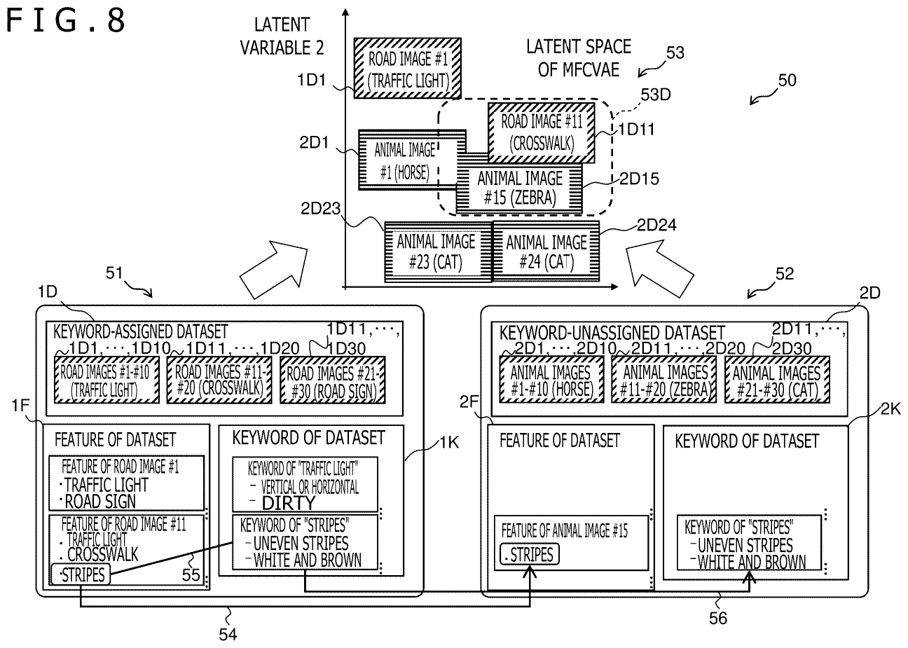

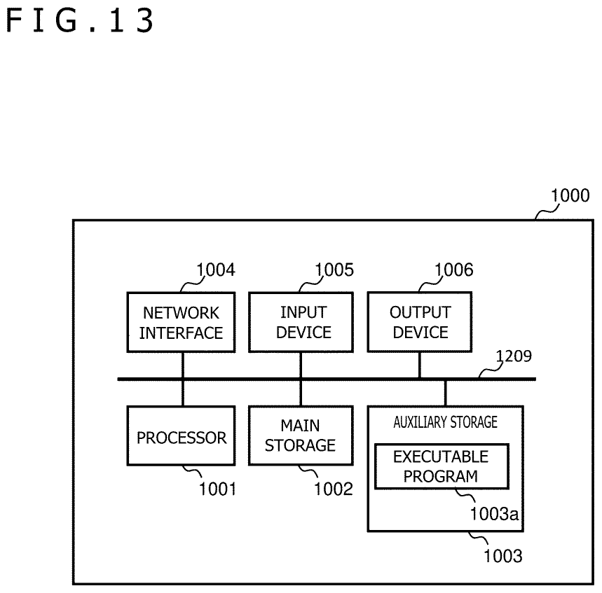

FIG. 8 is a diagram illustrating an example of a GUI 50 according to the first embodiment. The GUI 50 is to be displayed on a display screen of a later-described output device 1006 (FIG. 13).

A display area 51 of the GUI 50 depicted in FIG. 8 displays the images 1D1 to 1D30 of the keyword-assigned dataset 1D, the feature 1F of the images 1D1 to 1D30, and the keyword 1K linked to the feature 1F. Further, a display area 52 displays the images 2D1 to 2D30 of the keyword-unassigned dataset 2D.

Moreover, a display area 53 displays the distribution in the latent space of MFCVAE of each of the images 1D1 to 1D30 of the keyword-assigned dataset 1D and each of the images 2D1 to 2D30 of the keyword-unassigned dataset 2D, which is generated by the distribution generation process (FIGS. 3 and 4). The display area 53 displays an identification mark 53D indicating that, for example, the image 1D11 of the keyword-assigned dataset 1D and the image 2D15 of the keyword-unassigned dataset 2D form a combination of data determined to be the closest in distance by the keyword-assigned dataset selection process (FIGS. 3 and 5).

According to the identification mark 53D, the user of the risk analysis support system 1S references the image 1D11 (road image #11 (crosswalk)) and the image 2D15 (animal image #15 (zebra)). The user then selects “stripes” as the feature 1F of the image 1D11 that is common to these images.

The risk analysis support system 1S receives the input of the selected feature 1F, namely, the “stripes” (step S17a of the feature selection process (FIG. 6)). The feature “stripes” is then selected as the feature 2F of the image 2D15 by the risk analysis support system 1S as indicated by the arrow 54.

Further, as indicated by the solid line 55, “Uneven Stripes” and “White and Brown” are linked to the feature 1F, namely, “stripes,” as the keyword 1K. Therefore, the risk analysis support system 1S selects the keyword 1K, which is linked to the feature 1F, namely, “stripes,” as a keyword 2K, which is linked to “stripes” included in the feature 2F, as indicated by the arrow 56.

In the manner described above, the keyword 1K linked to the dataset in another domain can be reused to identify variations in data in a target dataset. This makes it possible to enrich the keywords for recalling the risks in the machine learning model, expand the variations in the target dataset, and reduce the omission of analysis of the risks in the machine learning model built by use of the target dataset.

### Second Embodiment

In the first embodiment, the keyword 1K to be linked to the feature 1F common to the keyword-unassigned dataset 2D is selected as the keyword 2K that is to be linked to the feature 2F of the keyword-unassigned dataset 2D. Meanwhile, in a second embodiment, the keyword-assigned dataset 1D to be linked to the keyword 1K selected as the keyword 2K to be linked to the feature 2F of the keyword-unassigned dataset 2D is limited to data that is still unselected since the feature 1F is common to the keyword-unassigned dataset 2D and is found to be an “unsuccessful inference” as the result of identification based on the machine learning model.

Consequently, it is possible to accurately identify data features and keywords that pose a risk of obtaining an identification result indicating the “unsuccessful inference.”

### Keyword-Assigned Dataset Selection Process According to Second Embodiment

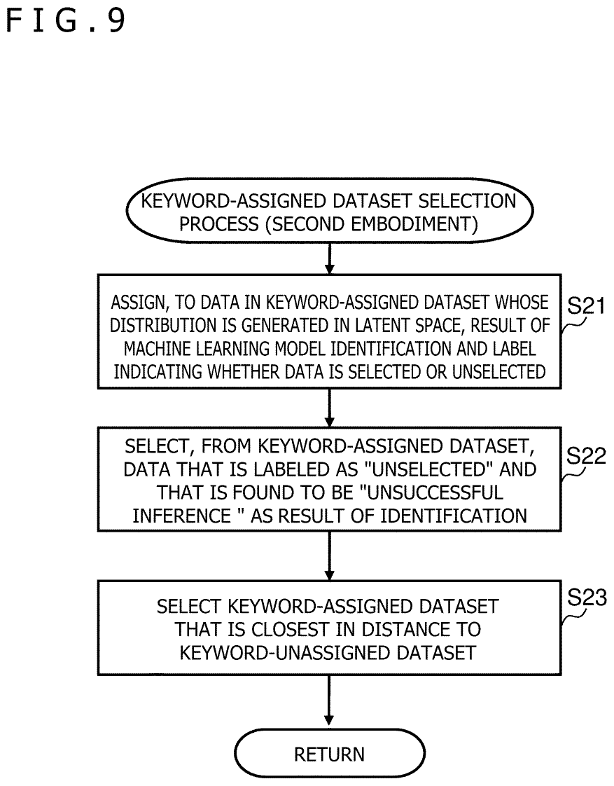

FIG. 9 is a flowchart illustrating an example of the keyword-assigned dataset selection process according to the second embodiment. The keyword-assigned dataset selection process according to the second embodiment is performed in step S16 (FIG. 3) of the main process of the risk analysis support system in place of the keyword-assigned dataset selection process (FIG. 5).

First, in step S21, the dataset selection section 13b assigns, to each data in the keyword-assigned dataset 1D whose distribution is generated in the latent space in step S15 (FIG. 3), the result of machine learning model identification and a label indicating whether data is selected or unselected. The machine learning model is a model learned in step S15a. The label indicating whether data is selected or unselected indicates whether the data is “selected or unselected” since the feature 1F of the corresponding data is common to the keyword-unassigned dataset 2D, and is changed from “unselected” to “selected” when the feature 1F of the corresponding data is selected.

Next, in step S22, the dataset selection section 13b selects, from the keyword-assigned dataset 1D, data that is labeled as “unselected” and is found to be an “unsuccessful inference” as the result of identification.

Next, in step S23, the dataset selection section 13b performs, on the dataset selected in step S22, a process similar to the keyword-assigned dataset selection process (FIG. 5) according to the first embodiment.

### Third Embodiment

In the first embodiment, the feature 1F and the keyword 1K of the keyword-assigned dataset 1D are applied only once to the keyword-unassigned dataset 2D. Meanwhile, a process of applying the feature 1F and the keyword 1K of the keyword-assigned dataset 1D multiple times to the keyword-unassigned dataset 2D will now be described in conjunction with a third embodiment.

### Main Process of Risk Analysis Support System According to Third Embodiment

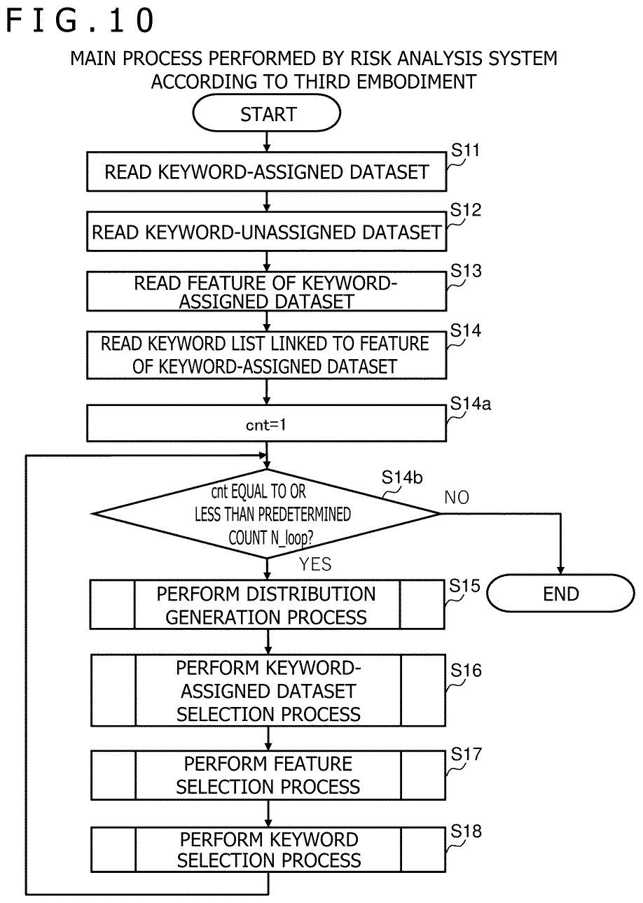

FIG. 10 is a flowchart illustrating an example of the main process that is performed by the risk analysis support system according to the third embodiment.

The main process of the risk analysis support system according to the third embodiment differs from the main process (FIG. 3) of the risk analysis support system in that step S14a is performed subsequently to step S14, and that steps S15 to S18 are repeatedly performed a predetermined number of times after completion of step S14b.

In step S14a, the distribution generation section 13a initializes a counter variable cnt to 1. Next, in step S14b, the distribution generation section 13a determines whether the value of the counter variable cnt is equal to or less than a predetermined count N_loop. If the value of the counter variable cnt is equal to or less than the predetermined count N_loop (YES in step S14b), the distribution generation section 13a proceeds to step S15. Meanwhile, if the value of the counter variable cnt is greater than the predetermined count N_loop (NO in step S14b), the distribution generation section 13a ends the main process.

However, in step S15 of the main process of the risk analysis support system according to the third embodiment, the distributions of the keyword-assigned dataset 1D and keyword-unassigned dataset 2D are generated while changing the type of latent space for each loop execution indicated by the counter variable cnt. The type of latent space is changed by changing the type of training dataset and/or encoder.

Further, the list L1 for each loop execution indicated by the counter variable cnt is used in the feature selection process (FIG. 6), which is performed in step S17 of the main process of the risk analysis support system according to the third embodiment. Further, the list L2 for each loop execution indicated by the counter variable cnt is used in the keyword selection process (FIG. 7), which is performed in step S18. In the manner described above, the lists L1 and L2 for each loop execution are used to store and output the features and the keywords, which vary from one loop execution to another.

In the present embodiment, the feature 1F of the data in the keyword-assigned dataset 1D and the keyword 1K to be linked to the feature 1F, which are to be assigned to the keyword-unassigned dataset 2D, can be extracted in multiple patterns by use of a plurality of latent spaces with different perspectives. This makes it possible to enrich the keywords for recalling the risks in the machine learning model, expand the variations in the target dataset, and reduce the omission of analysis of the risks in the machine learning model built by use of the target dataset.

### Fourth Embodiment

A fourth embodiment is configured to output and present the distribution of the keyword-assigned dataset 1D generated in the latent space in step S15 (FIG. 3).

### Distribution Generation Process According to Fourth Embodiment

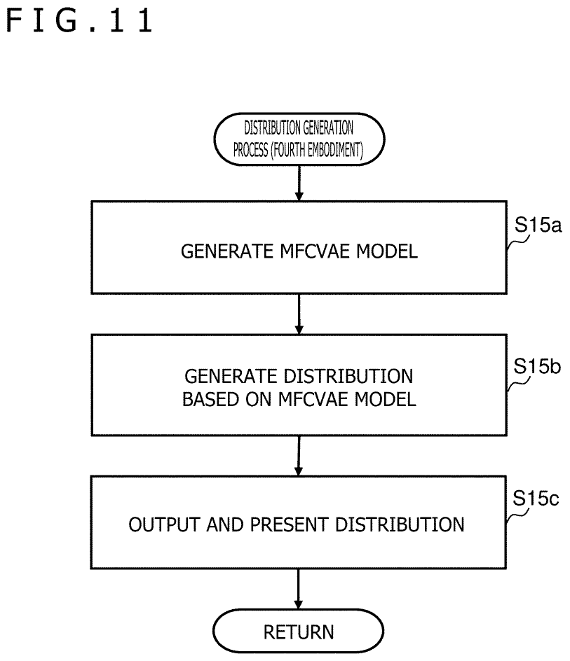

FIG. 11 is a flowchart illustrating an example of the distribution generation process according to the fourth embodiment. The distribution generation process according to the fourth embodiment differs from the distribution generation process according to the first embodiment (FIG. 4) in that step S15c is performed subsequently to step S15b. In step S15c, the distribution generation section 13a outputs and presents, through a GUI 50D, the distribution of the keyword-assigned dataset 1D, which is generated in step S15b. The GUI 50D is displayed on the display screen of the later-described output device 1006 (FIG. 13).

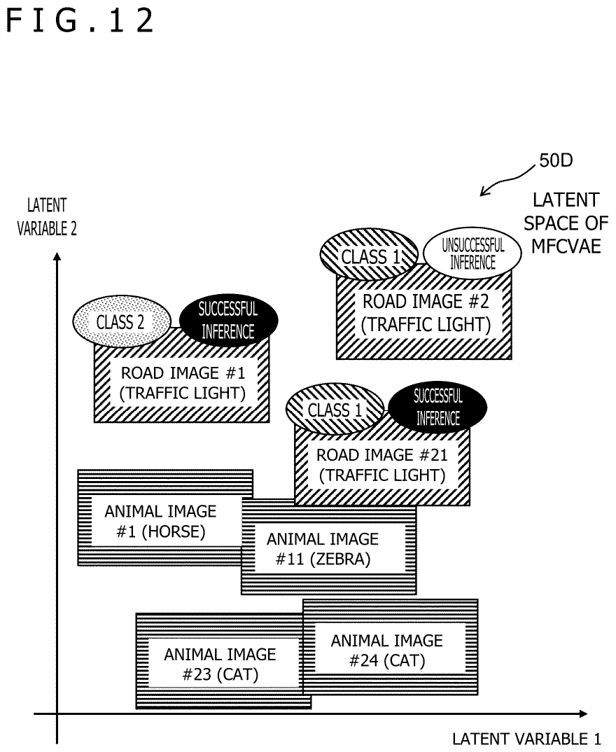

FIG. 12 is a diagram illustrating an example of the GUI 50D, which displays the distribution of the keyword-assigned dataset 1D according to the fourth embodiment. The GUI 50D displays a mixture of the keyword-assigned dataset 1D and the keyword-unassigned dataset 2D in the latent space based on the MFCVAE model. Further, the GUI 50D may display, as the keyword 2K to be output by the risk analysis support system 1S, not only a keyword previously used in the same domain as the target dataset, but also a keyword in a domain different from the target dataset.

### Fifth Embodiment

The first embodiment is configured such that the target dataset to which the keyword 1K linked to the feature 1F of the keyword-assigned dataset 1D is to be applied is the keyword-unassigned dataset 2D. However, the present invention is not limited to such a configuration. The target dataset to which the keyword 1K linked to the feature 1F of a certain keyword-assigned dataset 1D is to be applied may be another keyword-assigned dataset 1D.

In the fifth embodiment, the main process (FIG. 3) of the risk analysis support system according to the first embodiment is performed by rephrasing the “keyword-assigned dataset” as a “first keyword-assigned dataset” and rephrasing the “keyword-unassigned dataset” as a “second keyword-assigned dataset.”

Consequently, even in the case of the keyword-assigned dataset 1D, its feature 1F and keyword 1K can be enriched by use of the feature and keyword of another keyword-assigned dataset. This makes it possible to further reduce the omission of extraction of variations in the keyword-assigned dataset 1D.

### Hardware of Computer 1000

FIG. 13 is a hardware diagram illustrating a configuration of a computer 1000. For example, the risk analysis support system 1S, or each system in which the component elements of the risk analysis support system 1S, namely, the keyword-assigned dataset storage section 12a, the keyword-unassigned dataset storage section 12b, the feature storage section 12c, the keyword storage section 12d, the distribution generation section 13a, the dataset selection section 13b, the feature selection section 13c, and the keyword selection section 13d, are appropriately distributed, is implemented by the computer 1000.

The computer 1000 includes a processor 1001 including a CPU, a main storage 1002, an auxiliary storage 1003, a network interface 1004, an input device 1005, and the output device 1006, all of which are interconnected through an internal communication line 1009 such as a bus.

The processor 1001 controls the operation of the entire computer 1000. The main storage 1002 includes, for example, a volatile semiconductor memory, and is used as a work memory for the processor 1001. The auxiliary storage 1003 is an example of a non-transitory storage medium, and includes a large-capacity non-volatile storage device such as a hard disk device, an SSD (Solid State Drive), or flash memory, and is used to store various programs and data for a long period of time. The auxiliary storage 1003 functions as the keyword-assigned dataset storage section 12a, the keyword-unassigned dataset storage section 12b, the feature storage section 12c, and the keyword storage section 12d.

An executable program 1003a stored in the auxiliary storage 1003 is loaded into the main storage 1002 as needed and when the computer 1000 is to be started up, and the processor 1001 executes the executable program 1003a loaded into the main storage 1002. This implements the system and various functional sections (the distribution generation section 13a, the dataset selection section 13b, the feature selection section 13c, and the keyword selection section 13d) that perform various processes.

It is noted that the executable program 1003a may be recorded on a non-transitory recording medium, read from the non-transitory recording medium by a medium reading device, and loaded into the main storage 1002. Alternatively, the executable program 1003a may be obtained from an external computer through a network and loaded into the main storage 1002.

The network interface 1004 is an interface device for connecting the computer 1000 to each network in the system or for communicating with other computers. The network interface 1004 includes, for example, an NIC (Network Interface Card) for a wired LAN (Local Area Network) or a wireless LAN.

The input device 1005 includes, for example, a pointing device such as a keyboard or a mouse, and is used by the user to input various instructions and information to the computer 1000. The input device 1005 corresponds to the keyword-assigned dataset input section 11a, the keyword-unassigned dataset input section 11b, the feature input section 11c, and the keyword input section 11d.

The output device 1006 includes a display device such as a liquid-crystal display or an organic EL (Electro Luminescence) display, and an audio output device such as a speaker, and is used to present the user with necessary information when necessary. The GUIs 50 and 50D are displayed on the display screen of the display device included in the output device 1006.

It is noted that the present invention is not limited to the foregoing embodiments, but is intended to cover various modifications and similar arrangements included within the spirit and scope of the appended claims. For example, the foregoing embodiments have been described in detail to facilitate the understanding of the present invention, and the present invention is not necessarily limited to embodiments including all of the above-described configurations. Further, some of configurations in a certain embodiment may be replaced by configurations in another embodiment. Furthermore, configuration in a certain embodiment may be added to configuration in another embodiment. Moreover, some configurations of each embodiment may be added to, deleted from, or replaced with other configurations.

Additionally, for example, the above-described configurations, functions, processing sections, and processing means may be partly or wholly implemented by hardware, that is, for example, designed in a form of integrated circuits. Alternatively, individual functions may be implemented by software, that is, by allowing a processor to interpret and execute programs for implementing the functions.

Programs, tables, files, and other types of information for implementing the individual functions can be stored in storage devices such as memories, hard disks, and SSDs (Solid State Drives), or in non-transitory recording media such as IC (Integrated Circuit) cards, SD cards, and DVDs (Digital Versatile Discs).

Control lines and information lines considered necessary for explanation are depicted in this document, and all the control lines and information lines required for implementation are not necessarily depicted. In practice, almost all of the configurations may be considered interconnected.

### DESCRIPTION OF REFERENCE SIGNS

1S: Risk analysis support system
1D: Keyword-assigned dataset
1F, 1F1, . . . , 2F: Feature 1K, 1K1, . . . , 2K: Keyword
2D: Keyword-unassigned dataset
1000: Computer
1001: Processor
1002: Main storage
1005: Input device
1006: Output device

1. A risk analysis support system that supports risk analysis of a machine learning model, the risk analysis support device comprising:
a memory; and
a control section,
wherein the control section
reads a keyword-assigned dataset and a keyword-unassigned dataset, the keyword-assigned dataset being a dataset in which each data is assigned a feature of each data and assigned a keyword linked to the feature, the keyword-unassigned dataset being a dataset in which each data is not assigned a feature of each data and not assigned a keyword linked to the feature,
generates distribution of each data in the keyword-assigned dataset and the keyword-unassigned dataset in a latent space based on an amount of feature of a predetermined dataset,
selects, according to a distance between an amount of feature of each data in the keyword-assigned dataset and an amount of feature of each data in the keyword-unassigned dataset, first data in the keyword-assigned dataset that is similar to second data in the keyword-unassigned dataset, and
when there is a feature of the first data that is determined to be common to the second data, assigns the feature and a keyword linked to the feature to the second data.

2. The risk analysis support system according to claim 1,
wherein the predetermined dataset includes any one of or both the keyword-assigned dataset and the keyword-unassigned dataset, and
the latent space is a latent space of MFCVAE (Multi-Facet Clustering Variational Auto-Encoder).

3. The risk analysis support system according to claim 1,
wherein the control section,
when there is no feature of the first data that is determined to be common to the second data, adds, to the second data, a new feature determined to be common to the second data, and
links, to the new feature, a keyword selected from keywords linked to a feature of data in the keyword-assigned dataset.

4. The risk analysis support system according to claim 1,
wherein the control section
selects the first data with the distance equal to or less than a predetermined value from data that is in the keyword-assigned dataset, still unselected because of similarity to the second data, and is found to be an unsuccessful inference as a result of identification based on the machine learning model.

5. The risk analysis support system according to claim 1,
wherein the control section
generates the distribution of each data in the keyword-assigned dataset and the keyword-unassigned dataset in the latent space for each of a plurality of the different latent spaces,
selects the first data determined to be similar to the second data for each of the plurality of the different latent spaces, according to the distance between the amount of feature of each data in the keyword-assigned dataset and the amount of feature of each data in the keyword-unassigned dataset, and
when there is a feature of the first data that is determined to be common to the second data, assigns the feature and a keyword linked to the feature to the second data for each of the plurality of the different latent spaces.

6. The risk analysis support system according to claim 1,
wherein the control section
displays, on a display device, the generated distribution of each data in the keyword-assigned dataset and the keyword-unassigned dataset.

7. The risk analysis support system according to claim 1,
wherein the control section
reads a first keyword-assigned dataset and a second keyword-assigned dataset, the first and second keyword-assigned datasets which are datasets in which each data is assigned a feature and assigned a keyword linked to the feature,
generates distribution of each data in the first keyword-assigned dataset and the second keyword-assigned dataset in the latent space,
selects, according to a distance between an amount of feature of the first keyword-assigned dataset and an amount of feature of the second keyword-assigned dataset, third data in the first keyword-assigned dataset that is similar to fourth data in the second keyword-assigned dataset, and
when there is a feature of the third data that is determined to be common to the fourth data, assigns the feature and a keyword linked to the feature to the fourth data.

8. A risk analysis support method executed by a risk analysis support system that supports risk analysis of a machine learning model, the risk analysis support system including a memory and a control section, the risk analysis support method comprising processes of:
causing the control section to read a keyword-assigned dataset and a keyword-unassigned dataset, the keyword-assigned dataset being a dataset in which each data is assigned a feature of each data and assigned a keyword linked to the feature, the keyword-unassigned dataset being a dataset in which each data is not assigned a feature of each data and not assigned a keyword linked to the feature;
causing the control section to generate distribution of each data in the keyword-assigned dataset and the keyword-unassigned dataset in a latent space based on an amount of feature of a predetermined dataset;
causing the control section to select, according to a distance between an amount of feature of each data in the keyword-assigned dataset and an amount of feature of each data in the keyword-unassigned dataset, first data in the keyword-assigned dataset that is similar to second data in the keyword-unassigned dataset; and
when there is a feature of the first data that is determined to be common to the second data, causing the control section to assign the feature and a keyword linked to the feature to the second data.

9. The risk analysis support method according to claim 8,
wherein the predetermined dataset includes any one of or both the keyword-assigned dataset and the keyword-unassigned dataset, and
the latent space is a latent space of MFCVAE (Multi-Facet Clustering Variational Auto-Encoder).

10. The risk analysis support method according to claim 8, further comprising the processes of:
when there is no feature of the first data that is determined to be common to the second data, causing the control section to add, to the second data, a new feature determined to be common to the second data; and
causing the control section to link, to the new feature, a keyword selected from keywords linked to a feature of data in the keyword-assigned dataset.

11. The risk analysis support method according to claim 8,
wherein the control section
selects the first data with the distance equal to or less than a predetermined value from data that is in the keyword-assigned dataset, still unselected because of similarity to the second data, and is found to be an unsuccessful inference as a result of identification based on the machine learning model.

12. The risk analysis support method according to claim 8,
wherein the control section
generates the distribution of each data in the keyword-assigned dataset and the keyword-unassigned dataset in the latent space for each of a plurality of the different latent spaces,
selects the first data determined to be similar to the second data for each of the plurality of the different latent spaces, according to the distance between the amount of feature of each data in the keyword-assigned dataset and the amount of feature of each data in the keyword-unassigned dataset, and
when there is a feature of the first data that is determined to be common to the second data, assigns the feature and a keyword linked to the feature to the second data for each of the plurality of the different latent spaces.

13. The risk analysis support method according to claim 8, further comprising a process of:
causing the control section to display, on a display device, the generated distribution of each data in the keyword-assigned dataset and the keyword-unassigned dataset.

14. The risk analysis support method according to claim 8, further comprising the processes of:
causing the control section to read a first keyword-assigned dataset and a second keyword-assigned dataset which are datasets in which each data is assigned a feature and assigned a keyword linked to the feature;
causing the control section to generate distribution of each data in the first keyword-assigned dataset and the second keyword-assigned dataset in the latent space;
causing the control section to select, according to a distance between an amount of feature of the first keyword-assigned dataset and an amount of feature of the second keyword-assigned dataset, third data in the first keyword-assigned dataset that is similar to fourth data in the second keyword-assigned dataset; and
when there is a feature of the third data that is determined to be common to the fourth data, causing the control section to assign the feature and a keyword linked to the feature to the fourth data.

15. A risk analysis support program for causing a computer including a memory and a control section to function as a risk analysis support system that supports risk analysis of a machine learning model, the risk analysis support program comprising the processes of:
causing the computer to read a keyword-assigned dataset and a keyword-unassigned dataset, the keyword-assigned dataset being a dataset in which each data is assigned a feature of each data and assigned a keyword linked to the feature, the keyword-unassigned dataset being a dataset in which each data is not assigned a feature of each data and not assigned a keyword linked to the feature;
causing the computer to generate distribution of each data in the keyword-assigned dataset and the keyword-unassigned dataset in a latent space based on an amount of feature of a predetermined dataset;
causing the computer to select, according to a distance between an amount of feature of each data in the keyword-assigned dataset and an amount of feature of each data in the keyword-unassigned dataset, first data in the keyword-assigned dataset that is similar to second data in the keyword-unassigned dataset; and
when there is a feature of the first data that is determined to be common to the second data, causing the control section to assign the feature and a keyword linked to the feature to the second data.
